(19) United States
(12) Patent Application Publication
(10) Pub. No.: US 2019/0099836 A1
(43) Pub. Date: Apr. 4, 2019

(54) METHOD OF MANUFACTURING AN ARTICLE USING PRESSURIZING GAS

(71) Applicant: GM GLOBAL TECHNOLOGY OPERATIONS LLC, Detroit, MI (US)

(72) Inventors: Liang Wang, Rochester Hills, MI (US); Qigui Wang, Rochester Hills, MI (US); Daniel J Wilson, Linden, MI (US)

(21) Appl. No.: 15/723,272

(22) Filed: Oct. 3, 2017

(51) Int. Cl. B23K 26/342; B33Y 10/00; B33Y 40/00; B23K 26/12; B23K 26/144; B23K 15/00; B23K 9/04

(52) U.S. Cl. CPC B23K 26/342; B33Y 10/00; B33Y 40/00; B23K 9/04; B23K 26/144; B23K 15/0086; B23K 26/123

(57) ABSTRACT

A method for additive manufacturing of an article using pressurizing gas in an enclosure including introducing additive manufacturing equipment into the enclosure before sealing and removing air from the sealed enclosure to obtain a predetermined oxygen threshold. Next, the sealed enclosure is pressurized to obtain a predetermined pressure threshold using an inert gas. When the predetermined pressure threshold is obtained, the article is constructed using additive manufacturing.

### FIELD

Apparatuses consistent with exemplary embodiments relate to a method for manufacturing an article. More particularly, apparatuses consistent with an exemplary embodiment relate to a method for additive manufacturing (AM) of an article using pressurizing gas.

### BACKGROUND

The statements in this section merely provide background information related to the present disclosure and may or may not constitute prior art.

In the prototyping sector of product development, AM is proclaimed to be a fast and efficient means of creating parts before the parts go into the manufacturing stage of development. Further, advances in AM technology has made it feasible to manufacture low volume parts for commercial use, and it is plausible that future developments in AM technology will allow it to be considered for mass production.

While AM is a viable technology in terms of testing parts for form and fit to make sure that no design and engineering tweaks are necessary before any product is green-lighted for production, there are disadvantages in using the technology as well.

In AM-processed parts, porosity is the most commonly reported defect. The presence of porosity defects significantly decreases part mechanical properties. It has been reported that the fatigue strength of certain alloys produced using AM are significantly inferior to that of conventional materials. The lower fatigue strength is a consequence of multiple fatigue cracks propagating from the part surface porosity and/or internal voids which can grow during cyclic loading. It would be useful to develop an AM capable of improving the microstructure of AM parts.

### SUMMARY

One or more exemplary embodiments address the above issue by providing a method for additive manufacturing (AM) of an article using pressurizing gas.

According to an aspect of an exemplary embodiment, a method for additive manufacturing (AM) of an article using pressurizing gas includes introducing additive manufacturing equipment into the enclosure before sealing. Another aspect of the exemplary embodiment includes removing air from the sealed enclosure to obtain a predetermined oxygen threshold. Still another aspect as according to the exemplary embodiment includes injecting pressurized inert gas into the sealed enclosure to obtain a predetermined pressure threshold. Another aspect of the exemplary embodiment includes constructing the article using additive manufacturing when the sealed enclosure obtains the predetermined pressure threshold.

And a further aspect of the exemplary embodiment wherein introducing includes introducing the additive manufacturing equipment into a vacuum chamber.

In accordance with other aspects of the exemplary embodiment, wherein removing includes using a vacuum pump to remove air from the sealed enclosure. Still in accordance with aspects of the exemplary embodiment, wherein injecting includes injecting Argon gas. And another aspect of the exemplary embodiment wherein injecting includes injecting Nitrogen gas. Still another aspect wherein injecting includes injecting Helium gas.

Yet further aspects of the exemplary embodiment wherein constructing includes using metal wire as a construction material. And another aspect of the exemplary embodiment wherein constructing includes using metal powder as a construction material. And still another aspect wherein constructing includes delivering metal powder into the sealed enclosure using a powder feeder system.

### BRIEF DESCRIPTION OF THE DRAWINGS

The present exemplary embodiment will be better understood from the description as set forth hereinafter, with reference to the accompanying drawings, in which:

FIG. 1 is an illustration of a pressure assisted additive manufacturing (AM) system in accordance with an exemplary embodiment; and

FIG. 2 is an illustration of a flow diagram for a method for additive manufacturing (AM) of an article using pressurizing gas in accordance with the exemplary embodiment.

### DETAILED DESCRIPTION OF THE INVENTION

The following description is merely exemplary in nature and is not intended to limit the present disclosure, application, or uses thereof.

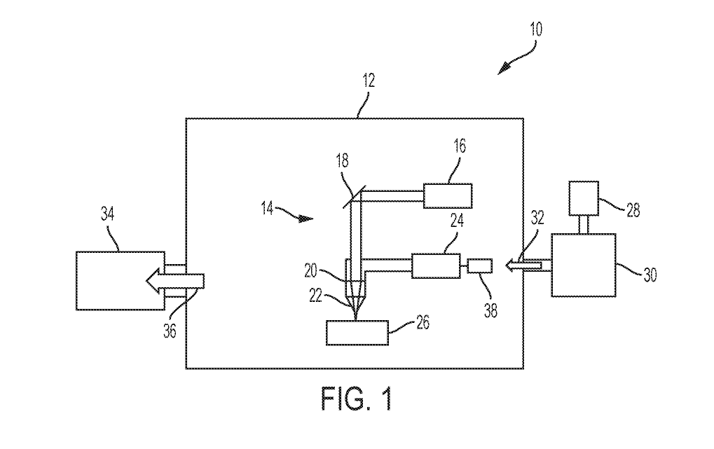

FIG. 1 provides an illustration of a pressure assisted additive manufacturing (AM) system 10 in accordance with an exemplary embodiment. It is appreciated that the article of manufacture 26 presented here as a basic cube is merely for the purpose of explaining the method for AM of an article in accordance with the exemplary embodiment and is not intended to limit the scope with regard to variety or geometric complexity of 3D articles that may be created from its use. In accordance with aspects of the exemplary embodiment, the article 26 may be made using various materials, e.g., metals, metal alloys, plastics, and thermoplastic resin materials when appropriate impregnation and heat treating are employed to the benefit of the article's functionality and structure.

In accordance with the exemplary embodiment, the pressure assisted additive manufacturing system 10 includes a sealable enclosure 12, preferably a vacuum chamber, from which air and other gases can be removed from or injected into through multiple ports using pumping devices suitable for such purposes. The enclosures preferably include instrumentation (not shown), e.g., sensors, gauges, cameras, microphones, etc., for monitoring the additive manufacturing process and the environment inside the enclosure.

Conventional additive manufacturing equipment 14 is disposed inside the enclosure 12 before it is sealed. The equipment includes an energy deposition source 16 in the form of a laser, electron beam, or plasma arc for melting the raw material 24 used in the additive manufacturing process for constructing the article. A mirror 18 is used to reflect and direct the beam from the energy deposition source 16 through a focus lens 20 and nozzle 22. The raw material 24 is melted when deposited from the nozzle 22 onto the existing surface of the article of manufacture 26.

Material 24 is continually added layer by layer to create until the article of manufacture 26 is completed. It is appreciated that after the multiple layers of material solidify, micro-sized spaces typically occur between material particles such that the article 26 created is highly porous at a microscopic level. These micro-sized spaces not only make the article 26 permeable to fluids but lessens its structural strength in comparison to a completely solid article of the same form and material. An improved AM process capable of substantially mitigating these microstructure deficiencies in AM parts is contemplated by this disclosure.

In accordance with aspects of the exemplary embodiment, the pressure assisted additive manufacturing system 10 further includes a gas pressurizing device 28 in communication with a supply of inert gas 30 which operates to deliver pressurized gas 32 into the sealed enclosure. The elevated pressure in the chamber may reduce the porosity of the manufactured article due to air entrapment to improve the microstructure and mechanical properties. Additionally, the pressure assisted additive manufacturing system 10 includes a vacuum pump 34 for removing air 36 from the sealed enclosure 12 to obtain a predetermined oxygen threshold such that the internal pressure level is slightly above normal atmospheric pressure prior to injecting the pressurized inert gas 32 to a predetermined pressure threshold. A powder feeder system 38 may be used to deliver metal powder into the sealed enclosure for constructing the article of manufacture. Alternatively, a metal wire feeding device (not shown) may be included in the system 10 for introducing the construction material into the sealed enclosure.

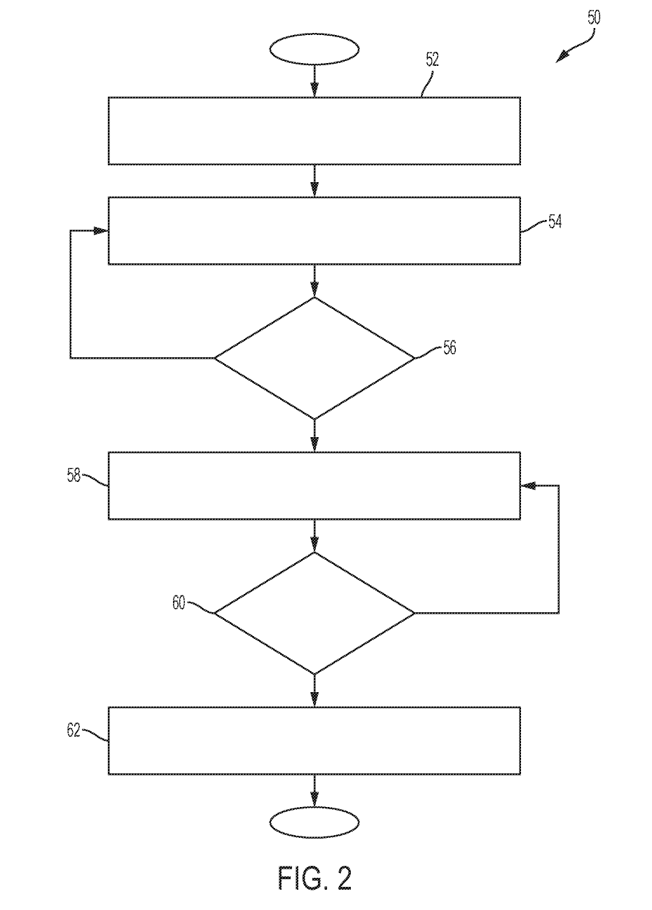

Referring now to FIG. 2, an illustration of a flow diagram 50 for a method for additive manufacturing (AM) of an article using pressurizing gas in accordance with the exemplary embodiment is presented. At block 52, the method begins with introducing the additive manufacturing equipment into the enclosure before sealing. As illustrated in FIG. 1, the gas pressurizer device (pump), the inert gas supply, and the vacuum pump are disposed external to the enclosure are communicated with internal environment through appropriately sealed fluid ports to maintain the integrity of the sealed environment in accordance with aspects of the exemplary embodiment.

At block 54, the method continues with removing air from the sealed enclosure to obtain a predetermined oxygen threshold. As mentioned above, this may be accomplished using a vacuum pump or other device suitable for such purpose. During the air extraction process, instrumentation is used for monitoring the oxygen level (at block 56) until the predetermined oxygen threshold is reached.

Next, when the predetermined oxygen threshold is obtained, at block 58, the method continues with injecting pressurized inert gas into the sealed enclosure to obtain a predetermined pressure threshold. An appropriate gas pressurizing system in connected to an inert gas supply, e.g., Helium, Nitrogen, Argon, etc., for delivering the pressurized gas into the enclosure. At block 60, appropriate instrumentation is used to monitor the internal environment until the predetermined pressure threshold is obtained through the injection of the inert gas.

Once the predetermined pressure threshold is obtained (block 60), it is continuously monitored and maintained and, at block 62, the method continues with constructing the article using the additive manufacturing process in accordance with the exemplary embodiment until the article is completed such that porosity is reduced due to air entrapment within the chamber to improve the microstructure and mechanical properties of the manufactured article.

What is claimed is:

1. A method for additive manufacturing (AM) of an article using pressurizing gas in an enclosure comprising:
introducing additive manufacturing equipment into the enclosure before sealing;
removing air from the sealed enclosure to obtain a predetermined oxygen threshold;
injecting pressurized inert gas into the sealed enclosure to obtain a predetermined pressure threshold; and
constructing the article using additive manufacturing when the sealed enclosure obtains the predetermined pressure threshold.

2. The method of claim 1 wherein introducing comprises introducing the additive manufacturing equipment into a vacuum chamber.

3. The method of claim 1 wherein removing comprises using a vacuum pump to remove air from the sealed enclosure.

4. The method of claim 1 wherein injecting comprises injecting Argon gas.

5. The method of claim 1 wherein injecting comprises injecting Nitrogen gas.

6. The method of claim 1 wherein injecting comprises injecting Helium gas.

7. The method of claim 1 wherein constructing comprises using metal wire as a construction material.

8. The method of claim 1 wherein constructing comprises using metal powder as a construction material.

9. The method of claim 8 wherein constructing includes delivering metal powder into the sealed enclosure using a powder feeder system.

10. A method for additive manufacturing (AM) of an article using pressurizing gas in a vacuum chamber comprising:
introducing additive manufacturing equipment into the vacuum chamber before sealing;
removing air from the vacuum chamber to obtain a predetermined oxygen threshold;
injecting pressurized inert gas into the vacuum chamber to obtain a predetermined pressure threshold; and
constructing the article using additive manufacturing when the vacuum chamber obtains the predetermined pressure threshold.

11. The method of claim 10 wherein removing comprises using a vacuum pump to remove air from the vacuum chamber.

12. The method of claim 10 wherein injecting comprises injecting Argon gas

13. The method of claim 10 wherein injecting comprises injecting Nitrogen gas.

14. The method of claim 10 wherein injecting comprises injecting Helium gas.

15. The method of claim 10 wherein constructing comprises using metal wire as a construction material.

16. The method of claim 10 wherein constructing comprises using metal powder as a construction material.

17. The method of claim 16 wherein constructing includes delivering metal powder into the sealed enclosure using a powder feeder system.
